(19) United States
(12) Patent Application Publication
(10) Pub. No.: US 2022/0266721 A1
(43) Pub. Date: Aug. 25, 2022

(54) ELECTRICALLY-POWERED VEHICLE, ENERGY SUPPLY APPARATUS, AND ENERGY SUPPLY SYSTEM

(71) Applicant: TOYOTA JIDOSHA KABUSHIKI KAISHA, Toyota-shi (JP)

(72) Inventor: Shigeki KINOMURA, Toyota-shi (JP)

(73) Assignee: TOYOTA JIDOSHA KABUSHIKI KAISHA, Toyota-shi (JP)

(21) Appl. No.: 17/665,156

(22) Filed: Feb. 4, 2022

(30) Foreign Application Priority Data
Feb. 25, 2021 (JP) 2021-029166

(51) Int. Cl. B60L 58/40; B60L 53/66

(52) U.S. Cl. CPC B60L 58/40; B60L 53/66; B60L 2270/40

(57) ABSTRACT

An electrically-powered vehicle that supplements energy independently from each of a plurality of supply apparatuses that supply the energy includes a controller. The controller is configured to, when vehicle control software of the electrically-powered vehicle, associated with first control software of at least one first supply apparatus of the plurality of supply apparatuses, is stored in a server capable of communicating with the electrically-powered vehicle, check for a support relationship between the vehicle control software and second control software of a second supply apparatus that is used by the electrically-powered vehicle at a higher frequency than the first supply apparatus, of the plurality of supply apparatuses, and, when there is no support relationship, restrict reception of the vehicle control software via communication with the server or an update based on the vehicle control software of the electrically-powered vehicle after the vehicle control software is received.

### CROSS-REFERENCE TO RELATED APPLICATION

This application claims priority to Japanese Patent Application No. 2021-029166 filed on Feb. 25, 2021, incorporated herein by reference in its entirety.

### BACKGROUND

### 1. Technical Field

The present disclosure relates to an electrically-powered vehicle, an energy supply apparatus, and an energy supply system.

### 2. Description of Related Art

There is known a technology that a server provides an electric vehicle with charging station information including information on the locations of charging stations, availability, and accessibility. Charging station information includes compatibility (for example, plug type support) between a charging station and an electric vehicle as availability (see, for example, Japanese Unexamined Patent Application Publication No. 2014-212690 (JP 2014-212690 A)).

### SUMMARY

Compatibility between an energy supply apparatus including a charging station and an electrically-powered vehicle including an electric vehicle is not only hardware compatibility, such as a plug type, but also software compatibility, such as a program for controlling the energy supply apparatus or the electrically-powered vehicle.

For an energy supply apparatus installed in a place, such as a public facility and a commercial facility, the energy supply apparatus can be updated to the latest state when the server periodically provides latest software to the energy supply apparatus via, for example, wired communication. When the server provides an electrically-powered vehicle with software for electrically-powered vehicles, having compatibility with the latest software, via, for example, wireless communication, the electrically-powered vehicle can be supplied with energy from the energy supply apparatus updated to the latest state to supplement energy.

However, an energy supply apparatus installed at home or the like where the frequency of use of an electrically-powered vehicle is high may irregularly acquire latest software from the server by manual operation. When forget to acquire the latest software, the support relationship between the electrically-powered vehicle provided with the software for electrically-powered vehicles and the energy supply apparatus installed at home or the like is lost, and the electrically-powered vehicle may not be able to supplement energy from the energy supply apparatus.

The present disclosure provides an electrically-powered vehicle, an energy supply apparatus, and an energy supply system that avoid a loss of the support relationship between two pieces of software that respectively control supply and supplement of energy.

An aspect of the present disclosure relates to an electrically-powered vehicle. The electrically-powered vehicle that supplements energy independently from each of a plurality of supply apparatuses that supply the energy includes a controller. The controller is configured to, when vehicle control software of the electrically-powered vehicle, associated with first control software of at least one first supply apparatus of the plurality of supply apparatuses, is stored in a server capable of communicating with the electrically-powered vehicle, check for a support relationship between the vehicle control software and second control software of a second supply apparatus that is used by the electrically-powered vehicle at a higher frequency than the first supply apparatus, of the plurality of supply apparatuses, and, when there is no support relationship, restrict reception of the vehicle control software via communication with the server or an update based on the vehicle control software of the electrically-powered vehicle after the vehicle control software is received.

In the above configuration, the controller may be configured to, when there is the support relationship, perform reception of the vehicle control software via communication with the server and an update based on the vehicle control software of the electrically-powered vehicle after the vehicle control software is received.

In the above configuration, the electrically-powered vehicle may further include a secondary battery as a power supply, and the plurality of supply apparatuses may be configured to supply electric power as the energy.

In the above configuration, the electrically-powered vehicle may further include a fuel cell as a power supply, and the fuel cell may use uses hydrogen, and the plurality of supply apparatuses may be configured to supply the hydrogen as the energy.

In the above configuration, a version of the first control software may be newer than a version of the second control software.

Another aspect of the present disclosure relates to an energy supply apparatus. The energy supply apparatus supplies energy to an electrically-powered vehicle. The energy supply apparatus includes a control unit. The control unit is configured to, when second control software of the energy supply apparatus, which is newer than first control software, associated with vehicle control software of the electrically-powered vehicle, of a different energy supply apparatus configured to supply the energy to the electrically-powered vehicle independently of the energy supply apparatus and used by the electrically-powered vehicle at a lower frequency than the energy supply apparatus, is stored in a server capable of communicating with the energy supply apparatus, check for a support relationship between the second control software and the vehicle control software, and, when there is no support relationship, restrict reception of the second control software or an update based on the second control software of the energy supply apparatus after the second control software is received.

In the above configuration, the controller may be configured to, when there is the support relationship, perform reception of the second control software and an update based on the second control software of the energy supply apparatus after the second control software is received.

Further another aspect of the present disclosure relates to an energy supply system. The energy supply system includes a plurality of supply apparatuses configured to supply energy, an electrically-powered vehicle configured to supplement the energy independently from each of the plurality of supply apparatuses, and a server capable of communicating with the plurality of supply apparatuses and the electrically-powered vehicle. The electrically-powered vehicle includes a controller. The controller is configured to, when vehicle control software of the electrically-powered vehicle, associated with first control software of at least one first supply apparatus of the plurality of supply apparatuses, is stored in the server, check for a support relationship between the vehicle control software and second control software of a second supply apparatus that is used by the electrically-powered vehicle at a higher frequency than the first supply apparatus, of the plurality of supply apparatuses, and, when there is no support relationship, restrict reception of the vehicle control software via communication with the server or an update based on the vehicle control software of the electrically-powered vehicle after the vehicle control software is received.

In the above configuration, the controller may be configured to, when there is the support relationship, perform reception of the vehicle control software via communication with the server and an update based on the vehicle control software of the electrically-powered vehicle after the vehicle control software is received.

According to the aspects of the present disclosure, it is possible to avoid a loss of the support relationship between two pieces of software that respectively control supply and supplement of energy.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram schematically showing the overall configuration of an energy supply system;

FIG. 2 is a diagram showing an example of the configuration of an electrically-powered vehicle;

FIG. 3 is an example of the hardware configuration of a vehicle management server;

FIG. 4 is an example of the functional configuration of the vehicle management server;

FIG. 5 is an example of a vehicle control software management table;

FIG. 6A is an example of a first support table;

FIG. 6B is an example of a second support table;

FIG. 7 is an example of the functional configuration of a station management server;

FIG. 8 is an example of a control software management table;

FIG. 9A is an example of the configuration of a first charging station;

FIG. 9B is an example of the configuration of a second charging station;

FIG. 10 is a process sequence diagram (part 1) showing an example of the operation of the energy supply system according to a first embodiment;

FIG. 11 is a process sequence diagram (part 2) showing an example of the operation of the energy supply system according to the first embodiment;

FIG. 12 is a process sequence diagram (part 1) showing an example of the operation of the energy supply system according to a second embodiment; and

FIG. 13 is a process sequence diagram (part 2) showing an example of the operation of the energy supply system according to the second embodiment.

### DETAILED DESCRIPTION OF EMBODIMENTS

Hereinafter, embodiments of the present disclosure will be described with reference to the accompanying drawings.

### First Embodiment

An energy supply system ST includes an electrically-powered vehicle 100, a management server group 200, and a plurality of charging stations 300. The electrically-powered vehicle 100 is not equipped with an engine and is equipped with an electrical storage device. The electrically-powered vehicle 100 is an electric vehicle capable of traveling with a motor by using electric power stored in the electrical storage device. The electrically-powered vehicle 100 also includes a plug-in electric vehicle (plug-in EV). The electrically-powered vehicle 100 may be a hybrid vehicle that is further equipped with an engine in addition to a motor or may be a fuel-cell vehicle that is equipped with a fuel cell that uses hydrogen as a fuel, instead of the electrical storage device or in addition to the electrical storage device. The electrically-powered vehicle 100 may be a privately-owned vehicle or may be a company-owned vehicle owned by a company.

The management server group 200 is installed in a data center DC that provides a cloud service. The management server group 200 includes various management servers such as a vehicle management server 210 and a station management server 220. The charging stations 300 include a first charging station 310 and a second charging station 320. Although not shown in the drawing, the charging stations 300 include a plurality of first charging stations and a plurality of second charging stations, in addition to the first charging station 310 and the second charging station 320. The charging stations 300 each are an example of a supply apparatus. The first charging station 310 is an example of a first supply apparatus and a different energy supply apparatus. The second charging station 320 is an example of a second supply apparatus and an energy supply apparatus.

The vehicle management server 210 and the station management server 220 are connected to each other by a wired communication network, such as a local area network (LAN). The vehicle management server 210 and the station management server 220 are connected to a communication network NW. The communication network NW is, for example, the Internet.

A cellular base station BS is connected to the communication network NW. When the electrically-powered vehicle 100 is included in a wireless communication area of the cellular base station BS, the cellular base station BS is able to communicate with the electrically-powered vehicle 100 via wireless communication WL. The cellular base station BS may also be regarded as being capable of communicating with the electrically-powered vehicle 100 by using over-the-air (OTA). Therefore, the electrically-powered vehicle 100 communicates with the vehicle management server 210 and the like via the communication network NW, the cellular base station BS, and the wireless communication WL. For example, a communication standard for wide-area wireless communication, such as Long Term Evolution (LTE), is used for the wireless communication WL.

The first charging station 310 and the second charging station 320 are connected to the communication network NW. The first charging station 310 is, for example, a quick charging station capable of supplying a direct-current power of several tens of kilowatts to several hundreds of kilowatts. The first charging station 310 is installed in, for example, a parking place of a public facility or commercial facility. The first charging station 310 is connected to a 200-volt three-phase alternating current power supply 312 via an electric power system 311 different from a communication system W1. On the other hand, the second charging station 320 is, for example, a standard charging station capable of supplying a direct-current power of several kilowatts. The second charging station 320 is installed in a home garage of a person who owns the electrically-powered vehicle 100 or a parking place of a company that owns the electrically-powered vehicle 100. The second charging station 320 is connected to a 100-volt or 200-volt single-phase alternating current power supply 322 via an electric power system 321 different from a communication system W2. In this way, since the second charging station 320 is installed in a personal home garage or a company parking place, the frequency of use of the second charging station 320 is higher than the frequency of use of the first charging station 310 that is temporarily used in the middle of a travel route. The frequency of use may be the number of uses per hour, may be the number of uses per day, may be the number of uses per month, or may be the number of uses per year.

The first charging station 310 and the second charging station 320 each supply electric power as energy to the electrically-powered vehicle 100 independently of each other. When, for example, the electrically-powered vehicle 100 is parked in a parking place where the first charging station 310 is installed, the first charging station 310 supplies electric power to the electrically-powered vehicle 100. Instead, when the electrically-powered vehicle 100 is parked in a garage where the second charging station 320 is installed, the second charging station 320 supplies electric power to the electrically-powered vehicle 100. The electrically-powered vehicle 100 is able to be charged with electric power supplied independently from each of the first charging station 310 and the second charging station 320.

The case where the electrically-powered vehicle 100 is charged with electric power supplied from the first charging station 310 will be specifically described. When electric power is supplied from the first charging station 310 to the electrically-powered vehicle 100, a first connector provided at the distal end of a charging cable extending from the first charging station 310 is connected to a first inlet of the electrically-powered vehicle 100. When an instruction to perform external charging is issued in the electrically-powered vehicle 100 or the first charging station 310, electric power is supplied from the first charging station 310 to the electrically-powered vehicle 100 through the charging cable. Thus, the electrically-powered vehicle 100 is able to supplement and charge electric power from the first charging station 310. The case where electric power is supplied from the second charging station 320 to the electrically-powered vehicle 100 is basically similar to the case of the first charging station 310, so the detailed description is omitted.

The vehicle management server 210 communicates with the electrically-powered vehicle 100 through the communication network NW, the cellular base station BS, and the wireless communication WL. The vehicle management server 210, for example, receives various pieces of information from the electrically-powered vehicle 100. The vehicle management server 210 transmits vehicle control software (specifically, a control program, firmware, or the like) for controlling the electrically-powered vehicle 100 to the electrically-powered vehicle 100. Vehicle control software includes supplement control software for controlling an operation related to supplement (that is, charging) of electric power. On the other hand, the station management server 220 communicates with the first charging station 310 and the second charging station 320 through the communication network NW. The station management server 220 receives various pieces of information from the first charging station 310 and the second charging station 320. The station management server 220 transmits control software for controlling the first charging station 310 to the first charging station 310. Similarly, the station management server 220 transmits control software for controlling the second charging station 320 to the second charging station 320. The pieces of control software include supply control software for controlling operation related to supply of electric power.

Although described in detail later, the station management server 220 periodically transmits new-version (specifically, latest-version) control software to the first charging station 310 collectively. When the first charging station 310 receives the new-version control software and is updated with the new-version control software, the first charging station 310 is in the latest state. In synchronization with transmission of the new-version control software by the station management server 220, the vehicle management server 210 transmits new-version vehicle control software having compatibility with the new-version control software to the electrically-powered vehicle 100. The electrically-powered vehicle 100 receives the new-version vehicle control software via the wireless communication WL and is updated with the new-version vehicle control software. Thus, the electrically-powered vehicle 100 is in the latest state.

On the other hand, the station management server 220 transmits new-version control software to the second charging station 320 in response to a request from the second charging station 320. When, for example, a user who uses the second charging station 320 manually operates the second charging station 320 to issue an instruction to transmit new-version control software, the second charging station 320 makes a request of the station management server 220 for the new-version control software. When periodical transmission of control software requires a high communication fee, some users may set transmission based on manual operation to the second charging station 320 without setting dynamic periodical transmission. When the second charging station 320 makes a request for transmission of the new-version control software, the station management server 220 transmits the new-version control software to the second charging station 320. The second charging station 320 receives the new-version control software and is updated with the new-version control software. Thus, the second charging station 320 is in the latest state. When the second charging station 320 is in the latest state, the second charging station 320 has compatibility with the electrically-powered vehicle 100 in the latest state, so the electrically-powered vehicle 100 is able to supplement electric power from the second charging station 320. In other words, the electrically-powered vehicle 100 is able to be charged from the second charging station 320.

Having compatibility means that there is a support relationship between pieces of software, and having no compatibility means that there is no support relationship between pieces of software. For compatibility related to charging, when there is a support relationship between the control software and the vehicle control software, output control and input control over electric power and communication normally operate. Thus, for example, the electrically-powered vehicle 100 is able to be charged at a fastest rate of charge. A charge completion time to completion of charging is able to be calculated with high accuracy. Other than the above, a screen guidance of the electrically-powered vehicle 100 or the first charging station 310, from which an instruction for external charging is issued, is able to be displayed normally. Therefore, when there is no support relationship between control software and vehicle control software, for example, the rate of charge may decrease, the accuracy of calculating a charging completion time may decrease, and the accuracy of displaying a screen guidance may decrease.

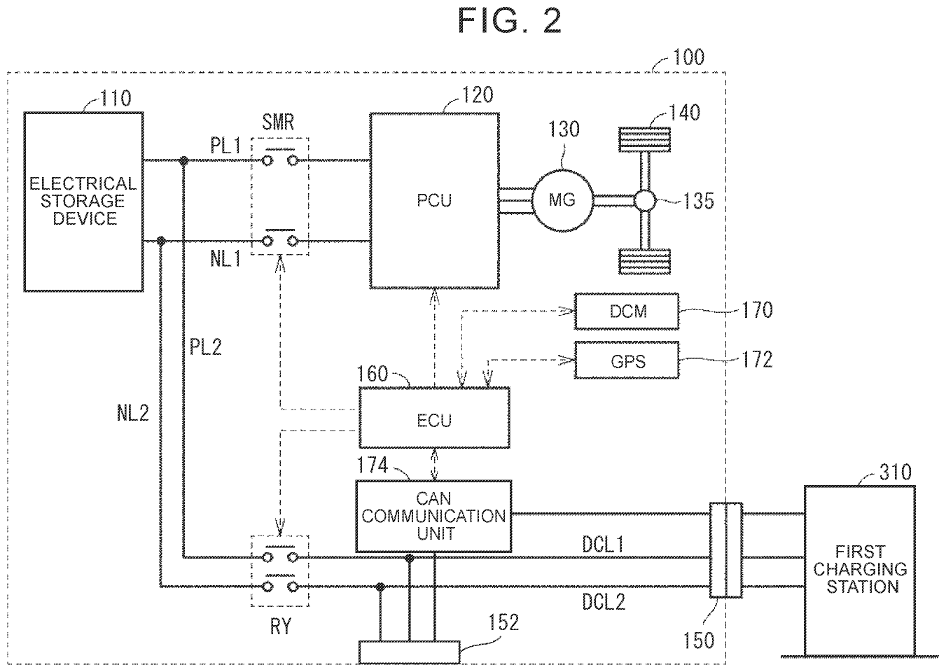

The configuration of the electrically-powered vehicle 100 will be described with reference to FIG. 2. The electrically-powered vehicle 100 includes an electrical storage device 110, a system main relay SMR, and a power control unit (PCU) 120. The electrically-powered vehicle 100 includes a motor generator (MG) 130, a power transmission gear 135, drive wheels 140, a first inlet 150, a second inlet 152, and a charging relay RY. The electrically-powered vehicle 100 includes an electronic control unit (ECU) 160, a data communication module (DCM) 170, a global positioning system (GPS) receiver 172, and a controller area network (CAN) communication unit 174. The ECU 160 includes a central processing unit (CPU), a random access memory (RAM), a read only memory (ROM), and an input and output interface (I/F).

The electrical storage device 110 is an electric power storage element configured to be chargeable and dischargeable. The electrical storage device 110 is, for example, a secondary battery, such as a lithium ion battery and a nickel-metal hydride battery, an electrical storage element, such as an electrical double-layer capacitor, or the like. A lithium ion battery is a secondary battery that uses lithium as a charge carrier. A lithium ion battery may be a lithium ion battery of which an electrolyte is liquid or may be an all-solid battery of which an electrolyte is solid.

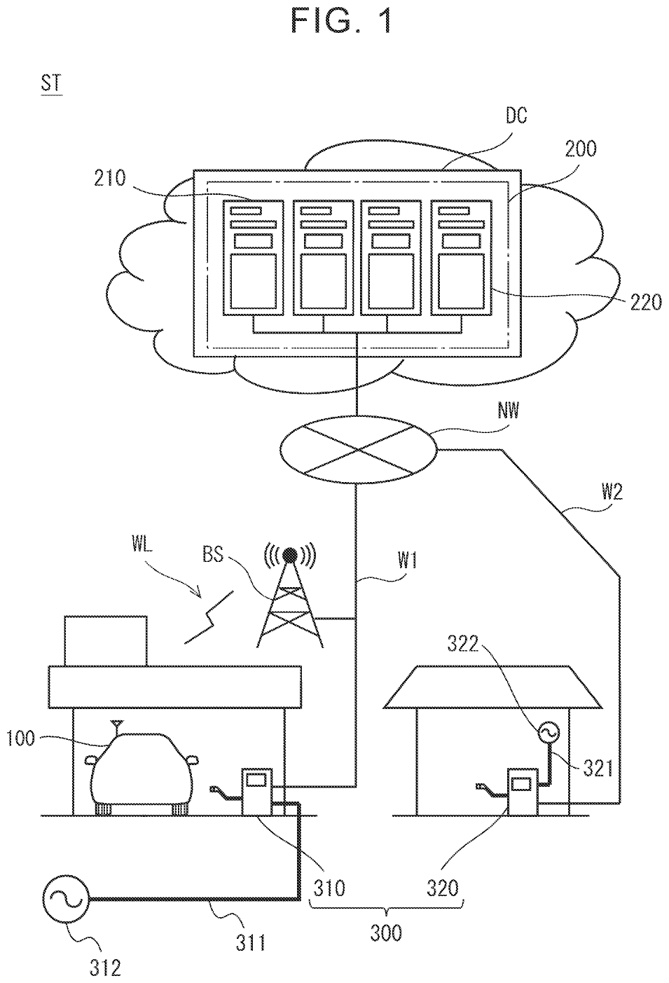

The electrical storage device 110 is charged (externally charged) through a charging cable by the first charging station 310 located outside the vehicle and connected to the first inlet 150. The electrical storage device 110 may be charged (externally charged) through a charging cable by the second charging station 320 (see FIG. 1) located outside the vehicle and connected to the second inlet 152. The electrical storage device 110 supplies electric power to the MG 130 through the PCU 120 during traveling. The electrical storage device 110 is charged with electric power generated by the MG 130 through the PCU 120 during regenerative power generation of the MG 130 in vehicle braking.

The system main relay SMR is provided between the PCU 120 and a pair of power lines PL1, NL1 connected to the electrical storage device 110. The system main relay SMR is turned on by the ECU 160 when a vehicle system is started up by a start switch (not shown), or the like.

The PCU 120 is a drive unit that drives the MG 130 and is made up of power conversion devices such as a converter and an inverter. The PCU 120 is controlled by the ECU 160 and converts direct-current power supplied from the electrical storage device 110 to alternating-current power for driving the MG 130. The PCU 120 converts alternating-current power generated by the MG 130 to direct-current power and outputs the direct-current power to the electrical storage device 110.

The MG 130 is an alternating-current rotating electrical machine and is, for example, a three-phase alternating-current synchronous motor in which permanent magnets are embedded in a rotor. The MG 130 is driven by the PCU 120 to generate rotational driving force, and the driving force generated by the MG 130 is transmitted to the drive wheels 140 through the power transmission gear 135. On the other hand, for example, during braking of the vehicle, the MG 130 operates as a generator and performs regenerative power generation. The electric power generated by the MG 130 is supplied to the electrical storage device 110 through the PCU 120.

The charging relay RY is provided between a pair of power lines DCL1, DCL2 connected to the first inlet 150 and the second inlet 152 and a pair of power lines PL2, NL2 connected to the pair of power lines PL1, NL1. The charging relay RY is turned on by the ECU 160 at the time of performing external charging.

The first inlet 150 receives electric power supplied from the first charging station 310 during external charging. During external charging, the first connector of the first charging station 310 is connected to the first inlet 150, and direct-current power output from the first charging station 310 is supplied to the electrical storage device 110 through the first inlet 150, the pair of power lines DCL1, DCL2, the charging relay RY, the pair of power lines PL2, NL2, and the pair of power lines PL1, NL1.

The second inlet 152 receives electric power supplied from the second charging station 320 (see FIG. 1) during external charging. During external charging, the second connector of the second charging station 320 is connected to the second inlet 152, and direct-current power output from the second charging station 320 is supplied to the electrical storage device 110 through the second inlet 152, the pair of power lines DCL1, DCL2, the charging relay RY, the pair of power lines PL2, NL2, and the pair of power lines PL1, NL1.

The DCM 170 is an onboard communication instrument for communicating with the vehicle management server 210 (see FIG. 1). The DCM 170 is capable of bidirectional communication between the electrically-powered vehicle 100 (specifically, the ECU 160) and the vehicle management server 210 through the wireless communication WL, the cellular base station BS, and the communication network NW. The GPS receiver 172 determines a current location based on radio waves from artificial satellites and outputs the determined location information to the ECU 160. Location information determined by the GPS receiver 172 is used in, for example, a navigation system (not shown) or the like.

The CAN communication unit 174 performs CAN communication between the electrically-powered vehicle 100 (specifically, the ECU 160) and the first charging station 310 or the second charging station 320 during external charging. In the present embodiment, an example in which DC charging is performed in accordance with CHAdeMO (registered trademark) mode is described, and communication between the electrically-powered vehicle 100 and the first charging station 310 is also performed in accordance with a CAN communication protocol employed in CHAdeMO.

A charge mode that can be employed in the electrically-powered vehicle 100 according to the present embodiment is not limited to the CHAdeMO mode, and, for example, a combined charging system (combo) mode for which standardization is being pursued mainly in Europe and the United States of America may also be employed. Communication between the electrically-powered vehicle 100 and the first charging station 310 or the second charging station 320 is also not limited to CAN communication employed in the CHAdeMO mode and may be performed by power line communication (PLC) or near field communication.

When the electrically-powered vehicle 100 is traveling, the ECU 160 controls drive of the MG 130 and charge and discharge of the electrical storage device 110 by turning on the system main relay SMR and controlling the PCU 120. During external charging, the ECU 160 performs external charging by turning on the charging relay RY and transmitting a charging start request, a charging current command value, and the like to the first charging station 310 or the second charging station 320 through the CAN communication unit 174. The ECU 160 calculates the state of charge (SOC) of the electrical storage device 110. When the SOC reaches a predetermined upper limit value, the ECU 160 transmits a charging stop request to the first charging station 310 or the second charging station 320 through the CAN communication unit 174 and turns off the charging relay RY. As for a method of calculating the SOC, known various methods, such as a method using an open circuit voltage (OCV)-SOC curve (map or the like) representing the relationship between OCV and SOC, a method using an integrated value of charging and discharging current, and Residual capacity/Full charge capacity ×100, may be used.

The charging cable of the first charging station 310 has the first connector connectable to the first inlet 150 of the electrically-powered vehicle 100. In a state where the first connector is connected to the first inlet 150, direct-current power can be supplied from the first charging station 310 to the electrically-powered vehicle 100, and CAN communication can be performed between the first charging station 310 and the electrically-powered vehicle 100. The second charging station 320 is basically similar to the first charging station 310, so the detailed description is omitted.

In a state where the first connector of the first charging station 310 is connected to the first inlet 150, data to be transmitted from the electrically-powered vehicle 100 to the first charging station 310 includes, for example, a charging start request, a charging stop request, a charging current command value, a charging voltage upper limit, and the like. Data to be transmitted from the first charging station 310 to the electrically-powered vehicle 100 includes, for example, maximum output information (such as available current value and available voltage value), current output information (such as a current output current value and a current output voltage value), and the like. The second charging station 320 is basically similar to the first charging station 310.

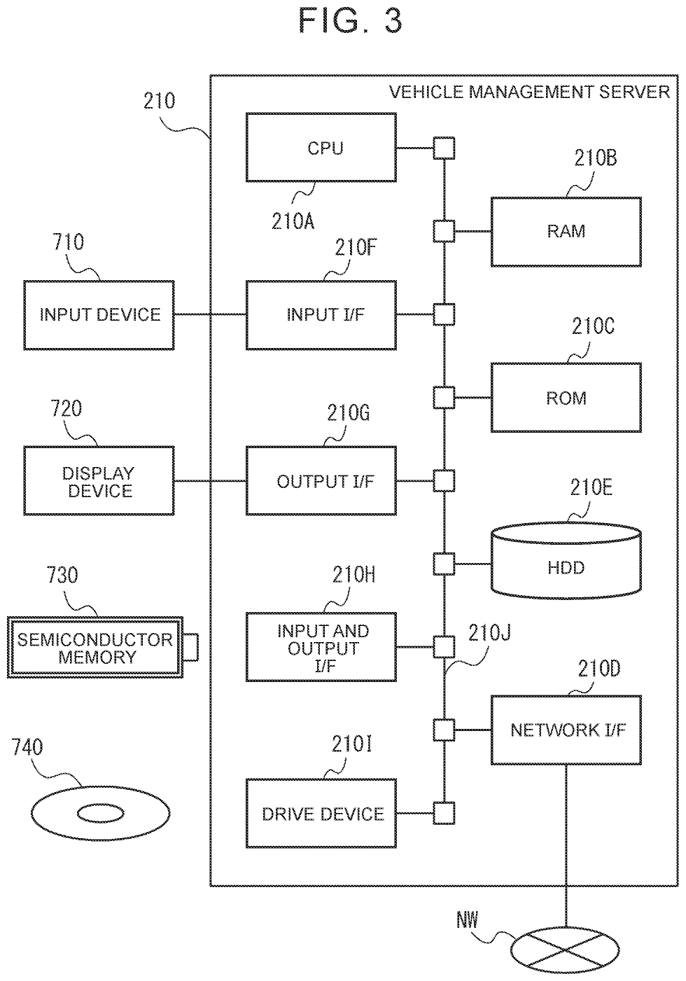

The hardware configuration of the vehicle management server 210 will be described with reference to FIG. 3. The station management server 220 basically has a similar hardware configuration to that of the vehicle management server 210, so the description thereof is omitted. As shown in FIG. 3, the vehicle management server 210 includes a CPU 210A serving as a processor, a RAM 210B and a ROM 210C serving as a memory, and a network I/F 210D. The vehicle management server 210, where necessary, may include at least one of a hard disk drive (HDD) 210E, an input I/F 210F, an output I/F 210G, an input and output I/F 210H, and a drive device 210I. The CPU 210A, the RAM 210B, the ROM 210C, the network I/F 210D, the HDD 210E, the input I/F 210F, the output I/F 210G, the input and output I/F 210H, and the drive device 210I are connected to one another by an internal bus 210J.

An input device 710 is connected to the input I/F 210F. A keyboard or a mouse (not shown) is an example of the input device 710. A display device 720 is connected to the output I/F 210G. A liquid crystal display is an example of the display device 720. A semiconductor memory 730 is connected to the input and output I/F 210H. For example, a universal serial bus (USB) drive, a flash memory, or the like is an example of the semiconductor memory 730. The input and output I/F 210H reads out a program or data stored in the semiconductor memory 730. The input I/F 210F and the input and output I/F 210H each include, for example, a USB port. The output I/F 210G includes, for example, a display port.

A portable recording medium 740 is inserted in the drive device 210I. For example, a removable disc, such as a compact disc (CD)-ROM and a digital versatile disc (DVD), is an example of the portable recording medium 740. The drive device 210I reads out a program or data stored in the portable recording medium 740. The network I/F 210D includes, for example, a LAN port. The network I/F 210D is connected to the communication network NW.

The program stored in the ROM 210C or the HDD 210E is temporarily stored in the RAM 210B by the CPU 210A. The program recorded on the portable recording medium 740 is temporarily stored in the RAM 210B by the CPU 210A. When the CPU 210A runs the stored program, the CPU 210A implements various functions (described later) and executes various processes (described later). A program just needs to be in accordance with a process sequence diagram (described later).

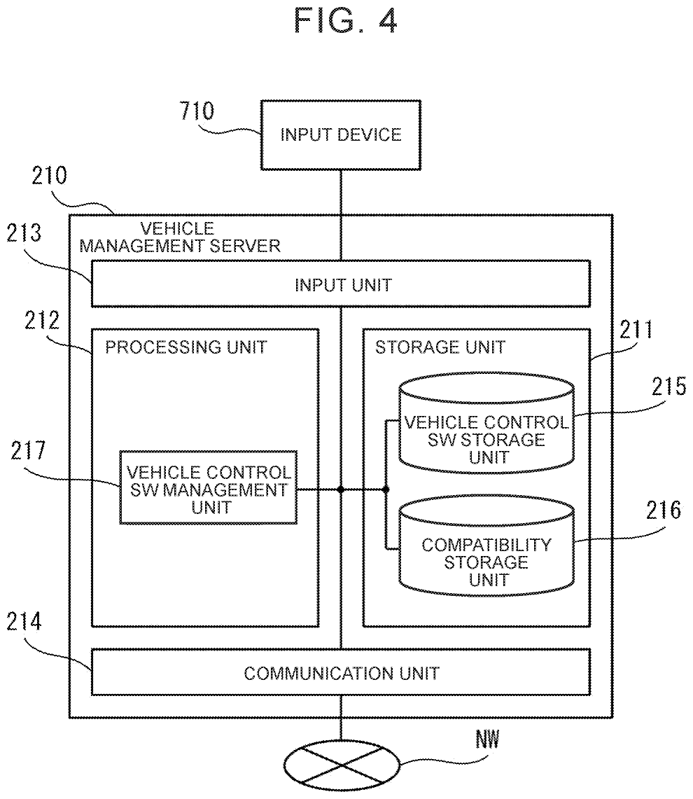

The functional configuration of the vehicle management server 210 will be described with reference to FIG. 4 to FIG. 6B. FIG. 4 shows a main part of the functions of the vehicle management server 210.

As shown in FIG. 4, the vehicle management server 210 includes a storage unit 211, a processing unit 212, an input unit 213, and a communication unit 214. The storage unit 211 is implemented by the RAM 210B, the HDD 210E, or the like. The processing unit 212 is implemented by the CPU 210A. The input unit 213 is implemented by the input I/F 210F. The communication unit 214 is implemented by the network I/F 210D. Therefore, the storage unit 211, the processing unit 212, the input unit 213, and the communication unit 214 are connected to one another.

The storage unit 211 includes a vehicle control software (hereinafter, referred to as SW) storage unit 215 and a compatibility storage unit 216 as components. At least one of the vehicle control SW storage unit 215 and the compatibility storage unit 216 may be provided in another management server different from the vehicle management server 210. In this case, the vehicle management server 210 may access another management server and reference details stored in the vehicle control SW storage unit 215 and the compatibility storage unit 216.

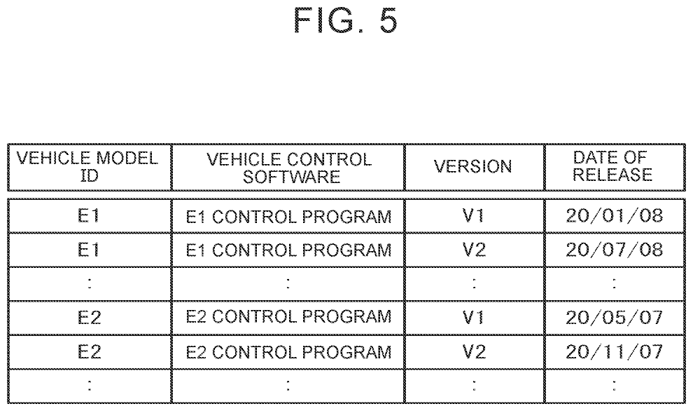

The vehicle control SW storage unit 215 stores vehicle control software in a vehicle control software management table. Specifically, as shown in FIG. 5, the vehicle control SW storage unit 215 stores vehicle model ID, vehicle control software, version, date of release, and the like in association with one another. A vehicle model ID is an identifier for identifying the electrically-powered vehicle 100. A version and a date of release are respectively the version and available date of vehicle control software. In the first embodiment, version “V1” corresponds to the old version of vehicle control software, and version “V2” corresponds to the new version of vehicle control software.

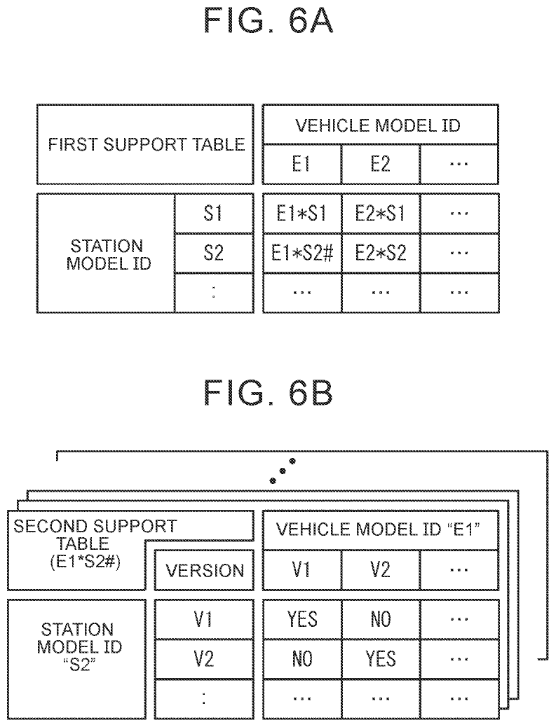

The compatibility storage unit 216 stores compatibility data on compatibility between the electrically-powered vehicle 100 and each of the first charging station 310 and the second charging station 320. Specifically, as shown in FIG. 6A and FIG. 6B, the compatibility storage unit 216 manages compatibility data by using a first support table and a plurality of second support tables.

As shown in FIG. 6A, the first support table manages a plurality of combinations of station model ID and vehicle model ID as compatibility data. A station model ID is an identifier for identifying the charging station 300. In the first embodiment, station model ID “S1” is assigned to the first charging station 310, and station model ID “S2” is assigned to the second charging station 320. A combination of station model ID and vehicle model ID is uniquely identified by using the first support table. A predetermined identifier is set for the station model ID of the charging station 300 of which the frequency of use is high for the electrically-powered vehicle 100. A predetermined identifier may be manually set or may be dynamically set by a vehicle control SW management unit 217 (described later) calculating the frequency of use. For example, a predetermined identifier “#” is set for a combination of station model ID “S2” and vehicle model ID “E1”. Thus, the electrically-powered vehicle 100 to which vehicle model ID “E1” is assigned is able to uniquely identify the second charging station 320 of which the frequency of use is high. For another electrically-powered vehicle (not shown) different from the electrically-powered vehicle 100 as well, a predetermined identifier is similarly set for the station model ID of the charging station 300 of which the frequency of use is high.

As shown in FIG. 6B, the second support tables each manage compatibility between the version of control software of the charging station 300 to which a station model ID is assigned and the version of vehicle control software of the electrically-powered vehicle 100 to which a vehicle model ID is assigned as compatibility data for each combination of station model ID and vehicle model ID. Compatibility “YES” indicates that there is compatibility between control software and vehicle control software. Compatibility “NO” indicates that there is no compatibility between control software and vehicle control software. Therefore, it indicates that there is no compatibility between version “V2” of control software of the second charging station 320 to which station model ID “S2” is assigned and version “V1” of vehicle control software of the electrically-powered vehicle 100 to which vehicle model ID “E1” is assigned. With the second support tables, it is possible to uniquely identify compatibility between a version of control software and a version of vehicle control software.

The processing unit 212 includes the vehicle control SW management unit 217. The vehicle control SW management unit 217 selectively accesses the components of the storage unit 211 and executes various processes. For example, when the vehicle control SW management unit 217 receives a request to transmit new-version vehicle control software from the electrically-powered vehicle 100, the vehicle control SW management unit 217 transmits new-version vehicle control software associated with the vehicle model ID of the electrically-powered vehicle 100 to the electrically-powered vehicle 100. The details of the vehicle control SW management unit 217 will be described when the operation of the energy supply system ST is described.

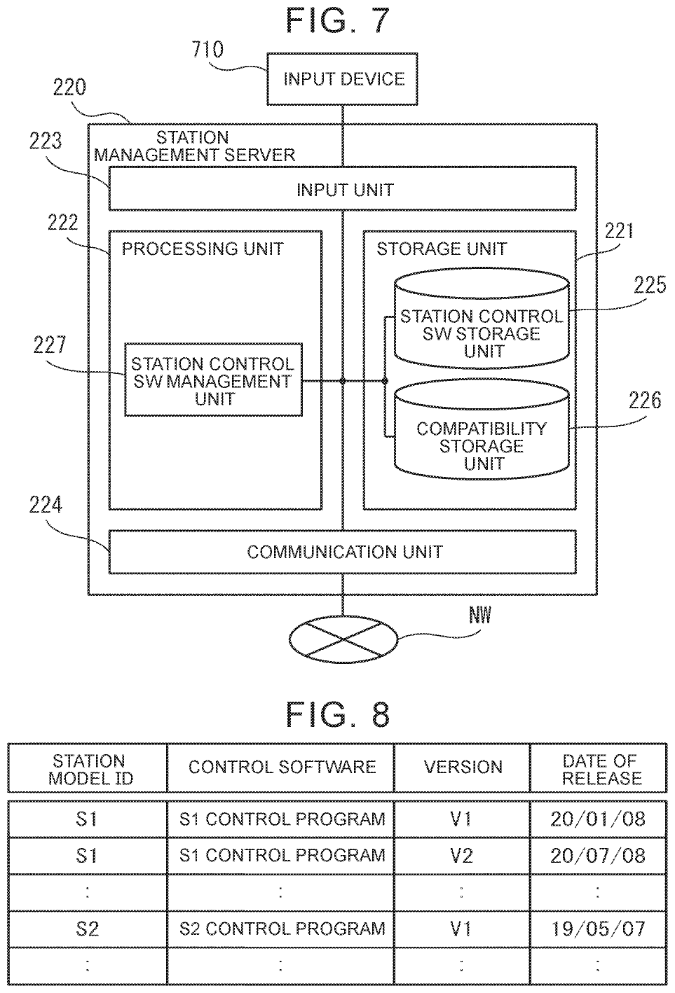

The functional configuration of the station management server 220 will be described with reference to FIG. 7 and FIG. 8. FIG. 7 shows a main part of the functions of the station management server 220.

As shown in FIG. 7, the station management server 220 includes a storage unit 221, a processing unit 222, an input unit 223, and a communication unit 224. The storage unit 221 is implemented by the RAM 210B, the HDD 210E, or the like. The processing unit 222 is implemented by the CPU 210A. The input unit 223 is implemented by the input I/F 210F. The communication unit 224 is implemented by the network I/F 210D. Therefore, the storage unit 221, the processing unit 222, the input unit 223, and the communication unit 224 are connected to one another.

The storage unit 221 includes a station control SW storage unit 225 and a compatibility storage unit 226 as components. At least one of the station control SW storage unit 225 and the compatibility storage unit 226 may be provided in another management server different from the station management server 220. In this case, the station management server 220 may access another management server and reference details stored in the station control SW storage unit 225 and the compatibility storage unit 226.

The station control SW storage unit 225 stores control software for controlling the charging station 300 in a control software management table. Specifically, as shown in FIG. 8, the station control SW storage unit 225 stores station model ID, control software, version, date of release, and the like in association with one another. A version and a date of release are respectively the version and available date of control software. As in the case of vehicle control software, version “V1” corresponds to the old version of control software, and version “V2” corresponds to the new version of control software. The compatibility storage unit 226, as well as the compatibility storage unit 216, stores compatibility data. Therefore, the detailed description of the compatibility storage unit 226 is omitted.

The processing unit 222 includes a station control SW management unit 227. The station control SW management unit 227 selectively accesses the components of the storage unit 221 and executes various processes. For example, when the station control SW management unit 227 receives a request to transmit new-version control software from the second charging station 320, the station control SW management unit 227 transmits new-version control software associated with the station model ID of the second charging station 320 to the second charging station 320. The details of the station control SW management unit 227 will be described when the operation of the energy supply system ST is described.

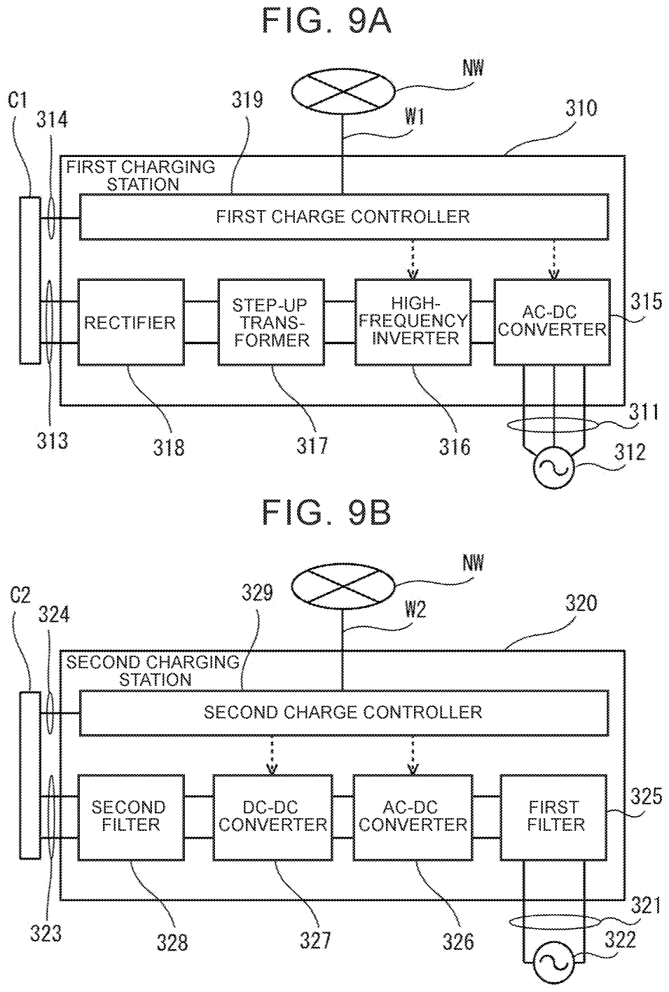

The configuration of the first charging station 310 will be described with reference to FIG. 9A. The first charging station 310 includes an AC-DC converter 315, a high-frequency inverter 316, a step-up transformer 317, a rectifier 318, and a first charge controller 319. The first charge controller 319 includes a CPU, a RAM, a ROM, an input and output I/F, and the like. A three-phase alternating current power supply 312 is connected to the AC-DC converter 315 via an electric power system 311. One end of a pair of first power lines 313 is connected to the rectifier 318. One end of a first communication line 314 is connected to the first charge controller 319. A first connector C1 is connected to the other end of the pair of first power lines 313 and the other end of the first communication line 314. The first connector C1 is able to connect with the first inlet 150 of the electrically-powered vehicle 100. The pair of first power lines 313 and the first communication line 314 are part of a charging cable extending from the first charging station 310 and included in the charging cable.

The AC-DC converter 315 receives electric power supplied from the three-phase alternating current power supply 312 and converts alternating-current power to direct-current power. The high-frequency inverter 316 converts direct-current power to high-frequency (rectangular wave) alternating-current power to enhance step-up efficiency. The step-up transformer 317 steps up high-frequency alternating-current power. The rectifier 318 rectifies and smooths stepped-up alternating-current power stepped up from high-frequency alternating-current power and outputs direct-current power via the first connector C1. The first charge controller 319 controls the operations of the AC-DC converter 315 and high-frequency inverter 316 while exchanging information such as the current SOC of the electrical storage device 110 with the ECU 160 (see FIG. 2) of the electrically-powered vehicle 100.

The configuration of the second charging station 320 will be described with reference to FIG. 9B. The second charging station 320 includes a first filter 325, an AC-DC converter 326, a DC-DC converter 327, a second filter 328, and a second charge controller 329. The second charge controller 329 includes a CPU, a RAM, a ROM, an input and output I/F, and the like. A single-phase alternating current power supply 322 is connected to the first filter 325 via an electric power system 321. One end of a pair of second power lines 323 is connected to the second filter 328. One end of a second communication line 324 is connected to the second charge controller 329. A second connector C2 is connected to the other end of the pair of second power lines 323 and the other end of the second communication line 324. The second connector C2 is able to connect with the second inlet 152 of the electrically-powered vehicle 100. The pair of second power lines 323 and the second communication line 324 are part of a charging cable extending from the second charging station 320 and included in the charging cable.

The first filter 325 suppresses the inflow of noise from the single-phase alternating current power supply 322 and the outflow of noise to the single-phase alternating current power supply 322 while receiving electric power supplied from the single-phase alternating current power supply 322. The AC-DC converter 326 converts alternating-current power received by the first filter 325 to direct-current power. The DC-DC converter 327 converts direct-current power output from the AC-DC converter 326 to direct-current power having a different voltage. The second filter 328 smooths direct-current power and outputs the direct-current power via the second connector C2. The second charge controller 329 controls the operations of the AC-DC converter 326 and DC-DC converter 327 while exchanging information such as the current SOC of the electrical storage device 110 with the ECU 160 (see FIG. 2) of the electrically-powered vehicle 100.

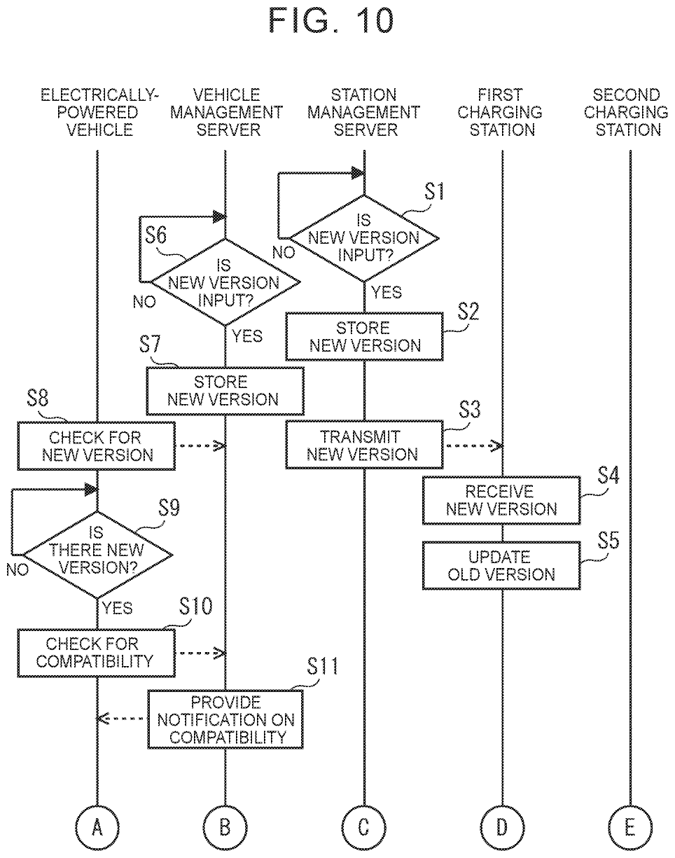

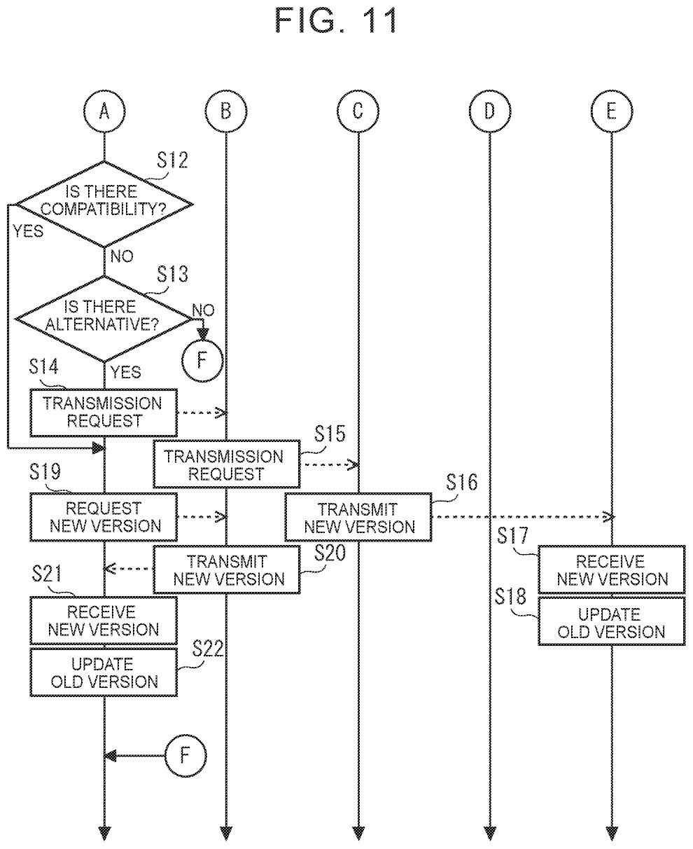

The operation of the energy supply system ST according to the first embodiment will be described with reference to FIG. 10 and FIG. 11. In FIG. 10 and FIG. 11, a continuation of process is represented by the character “A”, the character “B”, or the like.

Initially, as shown in FIG. 10, the station control SW management unit 227 of the station management server 220 waits until a new version of control software for controlling the operation of the first charging station 310 is input (NO in step S1). When a new version of control software is input (YES in step S1), the station control SW management unit 227 stores the new version of control software in the station control SW storage unit 225 (step S2). Therefore, when, for example, the new version “V2” of control software “S1 control program” for the first charging station 310 is input, the station control SW storage unit 225 stores the new version “V2” (see FIG. 8).

When the station control SW management unit 227 stores the new version of control software, the station control SW management unit 227 dynamically transmits the new version to the first charging station 310 (step S3). After the new version of control software is input, the station control SW management unit 227 may transmit the new version before storing the new version or may transmit the new version after storing the new version. The station control SW management unit 227 may transmit the new version of control software based on a set date and time, set time, or the like determined in advance.

When the new version of control software is transmitted, the first charge controller 319 of the first charging station 310 receives the new version of control software (step S4). When the first charge controller 319 receives the new version of control software, the first charge controller 319 updates the old version of control software with the new version of control software (step S5). When, for example, the old version “V1” of control software “S1 control program” is installed in the first charging station 310, the first charge controller 319 updates the old version “V1” with the new version “V2” of control software “S1 control program”. Thus, the first charge controller 319 is in the latest state.

On the other hand, the vehicle control SW management unit 217 of the vehicle management server 210 waits until a new version of vehicle control software for controlling the operation of the electrically-powered vehicle 100 is input (NO in step S6). When a new version of vehicle control software is input (YES in step S6), the vehicle control SW management unit 217 stores the new version of vehicle control software in the vehicle control SW storage unit 215 (step S7). Therefore, when, for example, the new version “V2” of vehicle control software “E1 control program” for the electrically-powered vehicle 100 is input, the vehicle control SW storage unit 215 stores the new version “V2” (see FIG. 5).

Before or after the processes of step S6 and step S7, the ECU 160 of the electrically-powered vehicle 100 periodically checks with the vehicle control SW management unit 217 for a new version of vehicle control software through the DCM 170 (step S8). The ECU 160 waits until the ECU 160 determines that there is a new version of vehicle control software (NO in step S9). When the ECU 160 determines that there is a new version of vehicle control software (YES in step S9), the ECU 160 checks with the vehicle control SW management unit 217 for compatibility (step S10). More specifically, the ECU 160 checks for the compatibility between vehicle control software and control software for controlling the second charging station 320. When the ECU 160 checks for compatibility, the ECU 160 transmits the vehicle model ID assigned to the ECU 160 or the DCM 170 to the vehicle control SW management unit 217.

When the vehicle control SW management unit 217 is requested from the ECU 160 to check for compatibility, the vehicle control SW management unit 217 provides notification on compatibility to the ECU 160 (step S11). More specifically, when the vehicle control SW management unit 217 is requested to check for compatibility, the vehicle control SW management unit 217 accesses the first support table (see FIG. 6A) and identifies a station model ID for which a predetermined identifier is set, from among station model IDs associated with the vehicle model ID transmitted at the time of checking for compatibility. In the present embodiment, the vehicle model ID “E1” is transmitted, so the vehicle control SW management unit 217 identifies station model ID “S2” for which the predetermined identifier “#” is set, from among station model IDs “S1”, “S2”, . . . . When the vehicle control SW management unit 217 identifies the station model ID “S2”, the vehicle control SW management unit 217 makes a request of the station control SW management unit 227 for control software installed in the second charging station 320 of the station model ID “S2” and its current version. Thus, the station control SW management unit 227 accesses the control software management table (see FIG. 8) and provides notification on control software and its current version, associated with the station model ID, to the vehicle control SW management unit 217. In the present embodiment, the station control SW management unit 227 provides notification on control software “S2 control program” and its current version “V1”, associated with station model ID “S2”, to the vehicle control SW management unit 217.

When the vehicle control SW management unit 217 receives the notification on control software and its current version from the station control SW management unit 227, the vehicle control SW management unit 217 identifies the second support table (see FIG. 6B) associated with a combination of the vehicle model ID and the station model ID. When the vehicle control SW management unit 217 identifies the second support table, the vehicle control SW management unit 217 provides notification on compatibility to the ECU 160 based on the identified second support table, the new version for update of vehicle control software checked and determined in the processes of step S8 and step S9 by the ECU 160, and the current version on which notification is provided from the station control SW management unit 227.

Referring to FIG. 11, the ECU 160 determines whether there is compatibility based on the notification from the vehicle control SW management unit 217 (step S12). When, for example, notification on compatibility “NO” is provided, the ECU 160 determines that there is no compatibility (NO in step S12). In the present embodiment, control software “S2 control program” associated with station model ID “S2” is version “V1” at a current point in time, and vehicle control software “E1 control program” associated with vehicle model ID “E1” is new version “V2”. For this reason, based on the second support table (see FIG. 6B), there is no compatibility between the two pieces of software. Therefore, notification on compatibility “NO” is provided, and the ECU 160 determines that there is no compatibility.

When there is no compatibility, the ECU 160 determines whether there is an alternative (step S13). When there is no compatibility, the ECU 160 may restrict (for example, cancel or stop) subsequent processes. When, for example, the ECU 160 updates control software for the second charging station 320 as an alternative, the ECU 160 determines whether there is compatibility with the new version of vehicle control software. In this case, the ECU 160 checks with the vehicle control SW management unit 217 for an alternative, and the vehicle control SW management unit 217 provides notification on presence or absence of an alternative to the ECU 160 based on the second support table. When there is no alternative (NO in step S13), the ECU 160 ends the process.

On the other hand, when there is an alternative (YES in step S13), the ECU 160 makes a request of the vehicle control SW management unit 217 to transmit the new version of control software for the second charging station 320 (step S14). When the vehicle control SW management unit 217 is requested from the ECU 160 to transmit the new version, the vehicle control SW management unit 217 makes a request of the station control SW management unit 227 to transmit the new version (step S15) since control software is managed by the station management server 220. When another new version “V2” newer than new version “V1” and associated with station model ID “S2” is managed in the control software management table, compatibility is ensured based on the second support table. Therefore, the station control SW management unit 227 transmits this new version of control software for the second charging station 320 to the second charge controller 329 of the second charging station 320 (step S16).

When the second charge controller 329 receives the new version of control software, transmitted from the station control SW management unit 227 (step S17), the second charge controller 329 updates control software based on the received new version of control software (step S18). In other words, the second charging station 320 is forcibly updated by the station control SW management unit 227. Thus, the second charging station 320 is in the latest state having compatibility with the electrically-powered vehicle 100.

On the other hand, when notification on compatibility “YES” is provided in the process of step S12, the ECU 160 determines that there is compatibility (YES in step S12). When, for example, compatibility “YES” is managed for a combination of the version “V2” of vehicle model ID “E1” and the version “V1” of station model ID “S2” in the second support table (see FIG. 6B), notification on compatibility “YES” is provided. In this way, when there is compatibility or when the process of step S14 is complete, the ECU 160 makes a request of the vehicle control SW management unit 217 for the new version of vehicle control software (step S19). In other words, the ECU 160 permits reception of the new version of vehicle control software and an update based on the received vehicle control software. Thus, the vehicle control SW management unit 217 transmits the new version of vehicle control software to the ECU 160 (step S20). In the present embodiment, the vehicle control SW management unit 217 transmits the new version “V2” of vehicle control software “E1 control program”.

When the ECU 160 receives the new version of vehicle control software, transmitted from the vehicle control SW management unit 217 (step S21), the ECU 160 updates the old version of vehicle control software with the new version based on the received new version of vehicle control software (step S22). In other words, the ECU 160 performs an update. Thus, the electrically-powered vehicle 100 is in the latest state having compatibility with both the first charging station 310 and the second charging station 320. As a result, it is possible to avoid a loss of the compatibility between control software for controlling supply of electric power and vehicle control software for controlling supplement of electric power.

### Second Embodiment

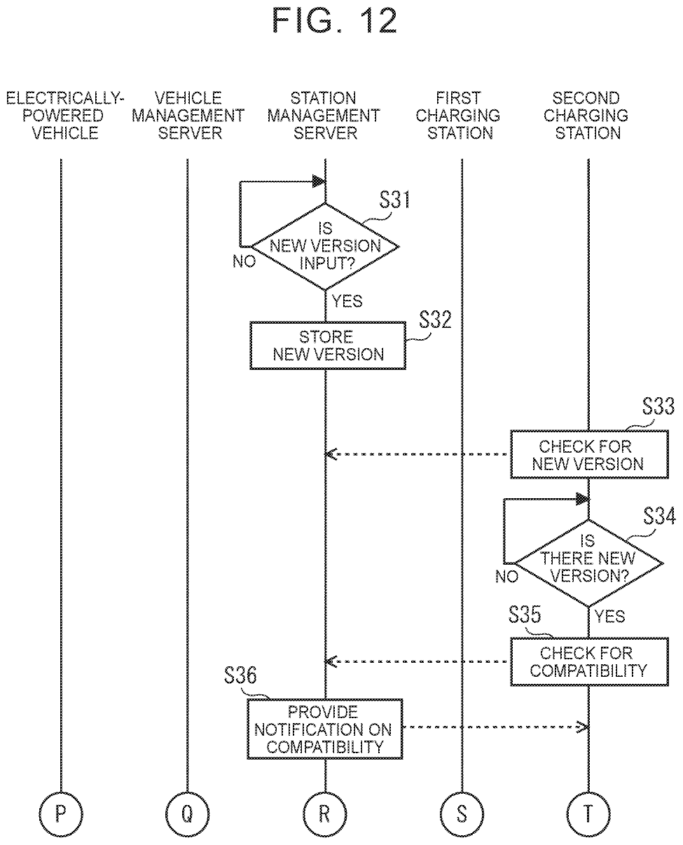

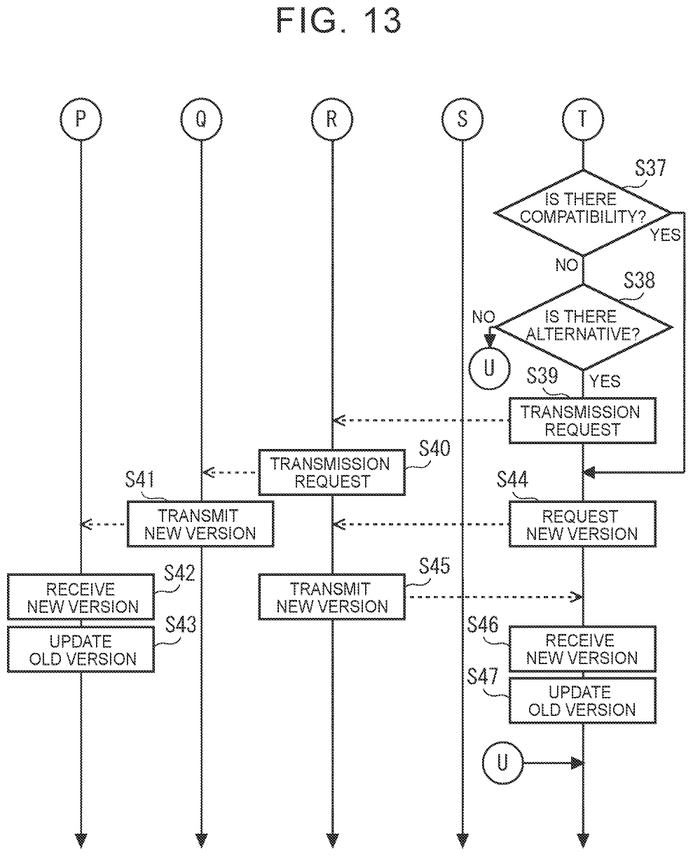

Next, the operation of an energy supply system ST according to a second embodiment will be described with reference to FIG. 12 and FIG. 13. In FIG. 12 and FIG. 13, a continuation of process is represented by the character “P”, the character “Q”, or the like.

Initially, as shown in FIG. 12, the station control SW management unit 227 of the station management server 220 waits until a new version of control software for controlling the operation of the second charging station 320 is input (NO in step S31). When a new version of control software is input (YES in step S31), the station control SW management unit 227 stores the new version of control software in the station control SW storage unit 225 (step S32). Therefore, when, for example, the new version “V2” of control software “S2 control program” for the second charging station 320 is input, the station control SW storage unit 225 stores the new version “V2”.

On the other hand, before or after the processes of step S31 and step S32, the second charge controller 329 of the second charging station 320 periodically checks with the station control SW management unit 227 for a new version of control software through the communication network NW (step S33). The second charge controller 329 waits until there is a new version of control software (NO in step S34). When the second charge controller 329 determines that there is a new version of control software (YES in step S34), the second charge controller 329 checks with the station control SW management unit 227 for compatibility (step S35). More specifically, the second charge controller 329 checks for the compatibility between vehicle control software and control software for controlling the second charging station 320. When the second charge controller 329 checks for compatibility, the second charge controller 329 transmits the station model ID assigned to the second charge controller 329 to the station control SW management unit 227.

When the station control SW management unit 227 is requested from the second charge controller 329 to check for compatibility, the station control SW management unit 227 provides notification on compatibility to the second charge controller 329 (step S36). More specifically, when the station control SW management unit 227 is requested to check for compatibility, the station control SW management unit 227 accesses the first support table (see FIG. 6A) of the compatibility storage unit 226 managed similarly as the compatibility storage unit 216 and identifies a vehicle model ID for which a predetermined identifier is set, from among vehicle model IDs associated with the station model ID transmitted at the time of checking for compatibility. In the present embodiment, the station model ID “S2” is transmitted, so the station control SW management unit 227 identifies vehicle model ID “E1” for which the predetermined identifier “#” is set, from among vehicle model IDs “E1”, “E2”, . . . . When the station control SW management unit 227 identifies the vehicle model ID “E1”, the station control SW management unit 227 makes a request of the vehicle control SW management unit 217 for vehicle control software installed in the electrically-powered vehicle 100 of the vehicle model ID “E1” and its current version. Thus, the vehicle control SW management unit 217 accesses the vehicle control software management table (see FIG. 5) and provides notification on vehicle control software and its current version, associated with the vehicle model ID, to the station control SW management unit 227. For example, the vehicle control SW management unit 217 provides notification on vehicle control software “E1 control program” and its current version “V1”, associated with vehicle model ID “E1”, to the station control SW management unit 227.

When the station control SW management unit 227 receives the notification on vehicle control software and its current version from the vehicle control SW management unit 217, the station control SW management unit 227 identifies the second support table (see FIG. 6B) of the compatibility storage unit 226, associated with a combination of the station model ID and the vehicle model ID. When the station control SW management unit 227 identifies the second support table, the station control SW management unit 227 provides notification on compatibility to the second charge controller 329 based on the identified second support table, the new version for update of control software checked and determined in the processes of step S33 and step S34 by the second charge controller 329, and the current version on which notification is provided from the vehicle control SW management unit 217.

Referring to FIG. 13, the second charge controller 329 determines whether there is compatibility based on the notification from the station control SW management unit 227 (step S37). When, for example, notification on compatibility “NO” is provided, the second charge controller 329 determines that there is no compatibility (NO in step S37). For example, vehicle control software “E1 control program” associated with vehicle model ID “E1” is version “V1” at a current point in time, and a version for update of control software “S2 control program” associated with station model ID “S2” is version “V2”. For this reason, based on the second support table (see FIG. 6B), there is no compatibility between the two pieces of software. Therefore, notification on compatibility “NO” is provided, and the second charge controller 329 determines that there is no compatibility.

When there is no compatibility, the second charge controller 329 determines whether there is an alternative (step S38). When there is no compatibility, the second charge controller 329 may restrict (for example, cancel or stop) subsequent processes. When, for example, the second charge controller 329 updates vehicle control software for the electrically-powered vehicle 100 as an alternative, the second charge controller 329 determines whether there is compatibility with the new version of control software. In this case, the second charge controller 329 checks with the station control SW management unit 227 for an alternative, and the station control SW management unit 227 provides notification on presence or absence of an alternative to the second charge controller 329 based on the second support table. When there is no alternative (NO in step S38), the second charge controller 329 ends the process.

On the other hand, when there is an alternative (YES in step S38), the second charge controller 329 makes a request of the station control SW management unit 227 to transmit the new version of vehicle control software for the electrically-powered vehicle 100 (step S39). When the station control SW management unit 227 is requested from the second charge controller 329 to transmit the new version, the station control SW management unit 227 makes a request of the vehicle control SW management unit 217 to transmit the new version (step S40) since vehicle control software is managed by the vehicle management server 210. When another new version “V2” newer than new version “V1” and associated with vehicle model ID “E1” is managed in the vehicle control software management table, compatibility is ensured based on the second support table. Therefore, the vehicle control SW management unit 217 transmits this new version of vehicle control software for the electrically-powered vehicle 100 to the ECU 160 of the electrically-powered vehicle 100 (step S41).

When the ECU 160 receives the new version of vehicle control software, transmitted from the vehicle control SW management unit 217 (step S42), the ECU 160 updates vehicle control software based on the received new version of vehicle control software (step S43). In other words, the electrically-powered vehicle 100 is forcibly updated by the vehicle control SW management unit 217.

On the other hand, when notification on compatibility “YES” is provided in the process of step S37, the second charge controller 329 determines that there is compatibility (YES in step S37). When, for example, compatibility “YES” is managed for a combination of the version “V2” of station model ID “S2” and the version “V1” of vehicle model ID “E1” in the second support table (see FIG. 6B), notification on compatibility “YES” is provided. In this way, when there is compatibility or when the process of step S39 is complete, the second charge controller 329 makes a request of the station control SW management unit 227 for the new version of control software (step S44). In other words, the second charge controller 329 permits reception of the new version of control software and an update based on the received control software. Thus, the station control SW management unit 227 transmits the new version of control software to the second charge controller 329 (step S45). In the present embodiment, the station control SW management unit 227 transmits the new version “V2” of control software “S2 control program”.

When the second charge controller 329 receives the new version of control software, transmitted from the station control SW management unit 227 (step S46), the second charge controller 329 updates the old version of control software with the new version based on the received new version of control software (step S47). In other words, the second charge controller 329 performs an update. Thus, the second charging station 320 is in the latest state having compatibility with the electrically-powered vehicle 100. As a result, it is possible to avoid a loss of the compatibility between control software for controlling supply of electric power and vehicle control software for controlling supplement of electric power.

The embodiments of the present disclosure are described in detail; however, the applicable embodiment is not limited to the above-described specific embodiments. Various modifications or alterations are applicable within the scope of the purport of the present disclosure described in the appended claims.

For example, in the above-described embodiments, the first charging station 310 is described as an example of a first supply apparatus and a different energy supply apparatus, and the second charging station 320 is described as an example of a second supply apparatus and an energy supply apparatus. Alternatively, when the electrically-powered vehicle 100 is a fuel-cell vehicle, a hydrogen station that supplies hydrogen as energy may be employed instead of the charging station 300. With such an embodiment, it is possible to avoid a loss of the compatibility between control software for controlling supply of hydrogen and vehicle control software for controlling supplement of hydrogen.

In the first embodiment, the electrically-powered vehicle 100 checks for compatibility and restricts or performs an update or the like of vehicle control software. Alternatively, the vehicle management server 210 may execute a similar process. In the first embodiment, the electrically-powered vehicle 100 receives a vehicle control program via wireless communication WL. Alternatively, the electrically-powered vehicle 100 may, for example, receive a vehicle control program via wired communication, such as the second communication line 324 included in the charging cable extending from the second charging station 320.

With regard to the above-described embodiments, the following supplemental note will be described.

### Addendum 1

An energy supply method of supplying energy to an electrically-powered vehicle that supplements the energy independently from each of a plurality of supply apparatuses includes, when vehicle control software of the electrically-powered vehicle, associated with first control software of at least one first supply apparatus of the plurality of supply apparatuses, is stored in a server capable of communicating with the electrically-powered vehicle, checking, by a controller of the electrically-powered vehicle, for a support relationship between the vehicle control software and second control software of a second supply apparatus that is used by the electrically-powered vehicle at a higher frequency than the first supply apparatus, of the plurality of supply apparatuses, and, when there is no support relationship, restricting, by the controller, reception of the vehicle control software via communication with the server or an update based on the vehicle control software of the electrically-powered vehicle after the vehicle control software is received.

What is claimed is:

1. An electrically-powered vehicle that supplements energy independently from each of a plurality of supply apparatuses that supply the energy, the electrically-powered vehicle comprising a controller configured to
when vehicle control software of the electrically-powered vehicle, associated with first control software of at least one first supply apparatus of the plurality of supply apparatuses, is stored in a server capable of communicating with the electrically-powered vehicle, check for a support relationship between the vehicle control software and second control software of a second supply apparatus that is used by the electrically-powered vehicle at a higher frequency than the first supply apparatus, of the plurality of supply apparatuses, and
when there is no support relationship, restrict reception of the vehicle control software via communication with the server or an update based on the vehicle control software of the electrically-powered vehicle after the vehicle control software is received.

2. The electrically-powered vehicle according to claim 1, wherein the controller is configured to, when there is the support relationship, perform reception of the vehicle control software via communication with the server and an update based on the vehicle control software of the electrically-powered vehicle after the vehicle control software is received.

3. The electrically-powered vehicle according to claim 1, wherein: the electrically-powered vehicle includes a secondary battery as a power supply; and the plurality of supply apparatuses is configured to supply electric power as the energy.

4. The electrically-powered vehicle according to claim 1, wherein: the electrically-powered vehicle includes a fuel cell as a power supply, and the fuel cell uses hydrogen as a fuel; and the plurality of supply apparatuses is configured to supply the hydrogen as the energy.

5. The electrically-powered vehicle according to claim 1, wherein a version of the first control software is newer than a version of the second control software.

6. An energy supply apparatus that supplies energy to an electrically-powered vehicle, the energy supply apparatus comprising a control unit configured to
when second control software of the energy supply apparatus, which is newer than first control software, associated with vehicle control software of the electrically-powered vehicle, of a different energy supply apparatus configured to supply the energy to the electrically-powered vehicle independently of the energy supply apparatus and used by the electrically-powered vehicle at a lower frequency than the energy supply apparatus, is stored in a server capable of communicating with the energy supply apparatus, check for a support relationship between the second control software and the vehicle control software, and
when there is no support relationship, restrict reception of the second control software or an update based on the second control software of the energy supply apparatus after the second control software is received.

7. The energy supply apparatus according to claim 6, wherein the controller is configured to, when there is the support relationship, perform reception of the second control software and an update based on the second control software of the energy supply apparatus after the second control software is received.

8. An energy supply system comprising:
a plurality of supply apparatuses configured to supply energy;
an electrically-powered vehicle configured to supplement the energy independently from each of the plurality of supply apparatuses; and
a server capable of communicating with the plurality of supply apparatuses and the electrically-powered vehicle, wherein:
the electrically-powered vehicle includes a controller configured to
when vehicle control software of the electrically-powered vehicle, associated with first control software of at least one first supply apparatus of the plurality of supply apparatuses, is stored in the server, check for a support relationship between the vehicle control software and second control software of a second supply apparatus that is used by the electrically-powered vehicle at a higher frequency than the first supply apparatus, of the plurality of supply apparatuses, and
when there is no support relationship, restrict reception of the vehicle control software via communication with the server or an update based on the vehicle control software of the electrically-powered vehicle after the vehicle control software is received.

9. The energy supply system according to claim 8, wherein the controller is configured to, when there is the support relationship, perform reception of the vehicle control software via communication with the server and an update based on the vehicle control software of the electrically-powered vehicle after the vehicle control software is received.
